(19) United States
(12) Patent Application Publication
(10) Pub. No.: US 2026/0212780 A1
(43) Pub. Date: Jul. 23, 2026

(54) NON-COGNITIVE SKILLS IMPROVEMENT SUPPORT SYSTEM AND NON-COGNITIVE SKILLS IMPROVEMENT SUPPORT METHOD

(71) Applicant: Specified Nonprofit Corporation Logica Academy, Osaka (JP)

(72) Inventors: Fukuo SEKI, Osaka (JP); Ai SEKI, Osaka (JP); Sou KUSABA, Osaka (JP)

(21) Appl. No.: 19/143,086

(22) PCT Filed: Aug. 14, 2024
(86) PCT No.: PCT/JP2024/028981

§ 371 Date: Jun. 25, 2025

(30) Foreign Application Priority Data
Aug. 18, 2023 (JP) 2023-133230

(51) Int. Cl. G09B 19/00; G06F 3/01

(52) U.S. Cl. CPC G09B 19/00; G06F 3/011; G06F 2203/011

(57) ABSTRACT

A non-cognitive skills improvement support system capable of efficiently supporting the improvement of non-cognitive skills. The non-cognitive skills improvement support system (1) includes an emotion information generating unit that generates emotion information based on biological information of a subject, a model input information generating unit that generates model input information to be input to a foundation model (200) based on the emotion information generated by the emotion information generating unit, a message generating unit that generates a message that is empathetic toward the subject and is intended to improve non-cognitive skills based on the model input information generated by the model input information generating unit, and an output unit (15) that outputs the message generated by the message generating unit to the subject.

### TECHNICAL FIELD

This disclosure relates to a non-cognitive skills improvement support system and a non-cognitive skills improvement support method for supporting the improvement of non-cognitive skills.

### BACKGROUND ART

Recently, research on non-cognitive skills has been progressing not only in Japan but also around the world, and the importance of non-cognitive skills is recognized. In Japan, while emphasis has been placed particularly on motivation, interest, and concern, less attention has been given to fostering important aspects of non-cognitive skills, such as perseverance and a willingness to take on a challenge. There has been a weak recognition that cognitive skills and non-cognitive skills are improved in an interwoven manner.

Perseveringly working with motivation and concern naturally causes deep thinking, devising ideas, and creating new things, which improves cognitive skills. As a result of the cognitive skills thus provided, a sense of accomplishment and a sense of fulfillment are obtained, and non-cognitive skills are enhanced, for example, “Let's try hard again.” Awareness of such a cycle allows effectively improving the cognitive skills and the non-cognitive skills.

Such an attitude and ability conventionally tend to be considered as a temperament and a personality, but nowadays, they are considered as “skills,” and the educational potential thereof is emphasized. For example, the interest and concern of children can be intentionally increased by preparing environments by educators.

Perseverance can be enhanced by encouragement. Purposely referring to them as “skills” indicates that children can achieve their goals with specific support. For example, a method for supporting the improvement of non-cognitive skills by indicating the achievement level of a learning plan is proposed (see Patent Document 1).

Patent Document 1: JP-A- 2016-218103

### DISCLOSURE OF THE INVENTION

### Problems to be Solved by the Invention

On the other hand, to improve the non-cognitive skills, it is important to appropriately grasp the condition of a subject.

This disclosure is intended to solve the above-described problem, and provides a non-cognitive skills improvement support system and a non-cognitive skills improvement support method capable of efficiently supporting the improvement of non-cognitive skills.

### Solutions to the Problems

A non-cognitive skills improvement support system of a first invention includes an emotion information generating unit that generates emotion information based on biological information of a subject, a model input information generating unit that generates model input information to be input to a foundation model based on the emotion information generated by the emotion information generating unit, a message generating unit that generates a message to improve non-cognitive skills including a message empathetic toward the subject based on the model input information generated by the model input information generating unit, and an output unit that outputs the message generated by the message generating unit to the subject.

In the non-cognitive skills improvement support system of a second invention, which is in the first invention, the foundation model is a large language model, and the model input information is a prompt input to the large language model.

The non-cognitive skills improvement support system of a third invention, which is in the first invention or the second invention, further includes an input information acquiring unit that acquires input information that the subject inputs to a device. The model input information generating unit generates the model input information based on the emotion information generated by the emotion information generating unit and the input information acquired by the input information acquiring unit.

The non-cognitive skills improvement support system of a fourth invention, which is in the third invention, further includes an input condition analyzing unit that analyzes the input information acquired by the input information acquiring unit to generate input condition information including an input proficiency level or a concentration level. The model input information generating unit generates the model input information based on the emotion information generated by the emotion information generating unit and the input condition information generated by the input condition analyzing unit.

In the non-cognitive skills improvement support system of a fifth invention, which is in the first invention or the second invention, the message generating unit further generates helpful information to improve non-cognitive skills based on the model input information generated by the model input information generating unit.

In the non-cognitive skills improvement support system of a sixth invention, which is in the first invention or the second invention, the emotion information generating unit generates the emotion information based on the biological information of the subject that does not perform an input to a device, and the output unit outputs the message to the subject by voice.

The non-cognitive skills improvement support system of a seventh invention, which is in the first invention or the second invention, further includes a reaction evaluating unit that evaluates a reaction of the subject after the output of the message.

In the non-cognitive skills improvement support system of an eighth invention, which is in the first invention or the second invention, the output unit outputs the message together with a character corresponding to the emotion information.

The non-cognitive skills improvement support system of a ninth invention, which is in the fourth invention, further includes an evaluating unit that evaluates an effort level of the subject for a task based on the input condition information, and a granting unit that provides a reward to the subject based on an evaluation result by the evaluating unit.

A non-cognitive skills improvement support method of a tenth invention includes an emotion information generating step of generating emotion information based on biological information of a subject, a model input information generating step of generating model input information to be input to a foundation model based on the emotion information generated in the emotion information generating step, a message generating step of generating a message to improve non-cognitive skills including a message empathetic toward the subject based on the model input information generated in the model input information generating step, and an output step of outputting the message generated in the message generating step.

### Effects Of The Invention

The non-cognitive skills improvement support system and the non-cognitive skills improvement support method of this disclosure can output the empathetic message that aligns with the emotion of the subject to the subject. Accordingly, the improvement of the non-cognitive skills of the subject can be efficiently supported.

### BRIEF DESCRIPTION OF THE DRAWINGS

FIG. 1 is a diagram schematically describing a non-cognitive skills improvement support system according to Embodiment 1.

FIG. 2 is a diagram describing the configuration of a non-cognitive skills improvement support system 1 according to Embodiment 1.

FIG. 3 is a diagram describing the configuration of function blocks of an information processing device 100 according to Embodiment 1.

FIG. 4 is a flowchart describing the process of the information processing device 100 according to Embodiment 1.

FIG. 5 is a diagram describing a subroutine flow of a reaction confirmation process according to Embodiment 1.

FIG. 6 is a diagram describing an exemplary prompt and answer text according to Embodiment 1.

FIG. 7 is a flowchart describing the process of an information processing device 100 according to Embodiment 2.

FIG. 8 is a flowchart describing an analysis process of an input condition according to Embodiment 2.

FIG. 9 is a flowchart describing an analysis process of an input condition according to Embodiment 3.

FIG. 10 is a diagram schematically describing a non-cognitive skills improvement support system according to Embodiment 3.

### DESCRIPTION OF PREFERRED EMBODIMENTS

The following describes a non-cognitive skills improvement support system 1 according to embodiments of this disclosure in detail with reference to the drawings. In the following description, the same reference numerals are attached to the same or equivalent parts in the drawings, and their explanations are not repeated in principle.

### Embodiment 1: Non-Cognitive Skills Improvement Support System 1

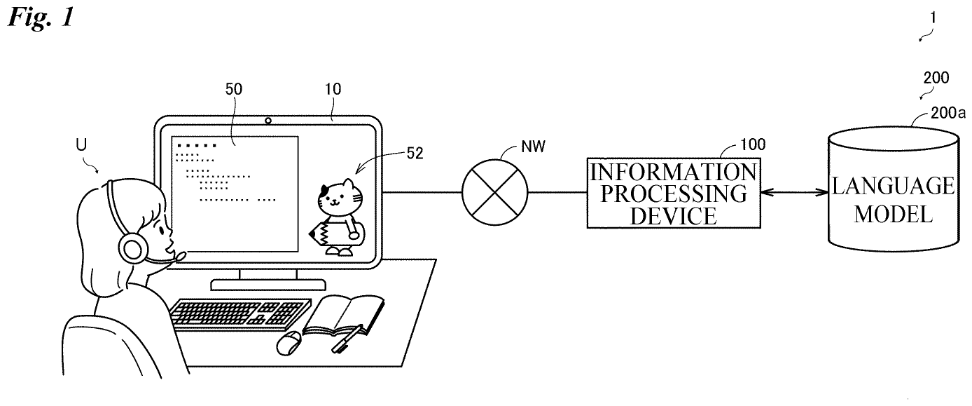

FIG. 1 is a diagram schematically describing a non-cognitive skills improvement support system 1 according to Embodiment 1. With reference to FIG. 1, the non-cognitive skills improvement support system 1 according to Embodiment 1 includes a terminal 10, a network NW, an information processing device 100, and a foundation model 200.

It is an object of the non-cognitive skills improvement support system 1 to attempt an improvement of non-cognitive skills of a subject (user U) through communication with the subject via the terminal 10. The communication performed by the non-cognitive skills improvement support system 1 includes text communication that outputs text data, audio communication that outputs voice data, visual communication that outputs image data or video data, video communication that outputs a combination of voice data and image or video data, and the like.

Here, the non-cognitive skills mean inner ability that is difficult to quantify through an intelligence test, an academic achievement test, and the like, and specifically mean ability relating to human emotions and social characteristics, such as motivation, perseverance, cooperativeness, and self-control. When the non-cognitive skills decline, it may become difficult for the user U to continue an activity, which may lead to halting the activity. Therefore, improving the non-cognitive skills of the user U is preferable because it leads to the attempt at continuing and maintaining the activity, thus improving the result of the activity of the user U.

For example, the non-cognitive skills improvement support system 1 generates information to be input to the foundation model 200 based on information indicative of an emotion of the user U, then generates a related message to improve the non-cognitive skills of the user U including a message empathetic toward the user U via the foundation model 200, and outputs the generated message to the user U. In this case, an empathetic message that aligns with the emotion of the user U can be output to the user U. In more detail, continuous communication with the user U including contents empathetic toward the emotion of the user U can be achieved through an answer corresponding to the information indicative of the emotion of the user U. This allows efficiently supporting the improvement of the non-cognitive skills of the user U.

### User U

The user U is a user of the non-cognitive skills improvement support system 1. The user U includes a person who explicitly or implicitly requires the improvement of non-cognitive skills of himself/herself through communication with the non-cognitive skills improvement support system 1.

For example, when the user U is conscious of a decline in non-cognitive skills of himself/herself, the user U may explicitly request communication for improving the non-cognitive skills from the non-cognitive skills improvement support system 1.

For example, when the user U is unconscious of a decline in non-cognitive skills of himself/herself, in a case in which the non-cognitive skills improvement support system 1 determines that the user U implicitly requests communication for improving the non-cognitive skills based on information on the user U that the non-cognitive skills improvement support system 1 actively or passively acquires, the communication with the non-cognitive skills improvement support system 1 is started even when an explicit request is not made.

The user U may be, for example, a requester of a communication partner or a requester of a personal assistant. The user U may be, for example, a learner including a student of a school, a student of a private tutoring school, and a participant of a seminar, training, e-learning, or the like. The user U may be, for example, a participant of independent living training (training for daily living) and motor function training, such as rehabilitation. The user U may be, for example, a participant of operation training of an operation simulator and the like of e-sports, a vehicle, and the like. The user U may be, for example, a consulter who requires an adviser about his/her own future carrier or requires business coaching. The user U may be, for example, a creator who creates artistic works, such as artworks including graphic art and the like and musical works including musical compositions and the like, through an operation of the terminal 10, or a creator of artistic works who creates artworks, such as paintings and sculptures, ballet works, dance works, song works, or the like, without using the terminal 10.

In the example of FIG. 1, the user U indicates a learner who learns programming using the terminal 10. The terminal 10 displays, for example, a learning screen 50 for programming learning, and the learning screen 50 indicates a case in which a character 52 is provided as an example.

### Foundation Model 200

The foundation model 200 means a publicly known AI model that performs learning with large-scale training data in advance and generates an appropriate answer in response to an input of various kinds of data. For example, as illustrated in FIG. 1, the foundation model 200 includes a large language model 200a (LLM: Large Language Model), and additionally includes generative AI (Generative AI) that generates data corresponding to input text data.

For example, the foundation model 200 may include a multimodal foundation model (LMM: Large Multi modal foundation Model) that generates an answer of multimodal data in response to an input of a wide variety of data types (multimodal data), such as text data including a prompt and a query, and additionally voice data, image data, video data, and sensor data that cannot be captured by five senses of a human.

The text data includes language information, such as a text and a character.

The voice data includes, in addition to the above-described language information, paralinguistic information that complements the language information, such as the tone and the inflection of the user U's voice.

The image data includes, in addition to the above-described language information, for example, image information, such as a graphic, body motion information including an expression, a gesture, and the like, physical attribute information including the age, gender, physical size, chronic disease, and the like of the user U, space information including the distance, the positional relation, and the like between the user U and the non-cognitive skills improvement support system 1, and environment information including a usage environment of the non-cognitive skills improvement support system 1 and the like.

The video data is configured of combinations of a plurality of pieces of information continuous with one another in various kinds of information included in the above-described image data. The video data includes change information (progress information) with a higher information volume than the image data, operation information including an operation content and the like on the non-cognitive skills improvement support system 1, and the like. The video data may include a combination of the change information or the operation information and various kinds of information included in the voice data.

The sensor data includes the temperature, humidity, and atmospheric pressure in the usage environment of the non-cognitive skills improvement support system 1, the pulse wave, brain wave, body temperature, expression, and speed or acceleration rate of the movement of the user U, and the like.

The foundation model 200 includes, for example, a question receiving unit 201, an answer generating unit 202, and a database (DB) 204. The question receiving unit 201 receives an inquiry about a message related to the non-cognitive skills to improve the non-cognitive skills from the information processing device 100. The answer generating unit 202 analyzes the received message, refers to the database 204 based on the analysis result, generates an answer including a message related to the non-cognitive skills to the inquiry, and transmits the answer to the information processing device 100. The database 204 includes a large amount of data for generating an answer.

Here, a question that the foundation model 200 receives includes, in addition to the inquiry to the foundation model 200, a request from the user U, for example, an instruction and a command to the foundation model 200. The answer that the foundation model 200 generates includes, in addition to the answer corresponding to the question to the foundation model 200, an answer corresponding to the content of an input including the request from the user U, for example, an instruction and a command to the foundation model 200.

When a result of training (pre-training) preliminarily performed using a large amount of data is stored in the foundation model 200 in advance, the foundation model 200 does not necessarily need to refer to the database 204. In this case, when an input of the inquiry received via the question receiving unit 201 is accepted, the foundation model 200 generates the answer including the message related to the non-cognitive skills to the inquiry based on the analysis result without referring to the database 204, and transmits the answer to the information processing device 100.

<<Large Language Model (LLM) 200a>>

The LLM 200a is a natural language processing system that performs a question and answer. The LLM 200a is a natural language processing model trained using a large amount of text data, has text data including texts and characters as an input, and outputs the text data including texts and characters. At this time, as the database 204, for example, a text database including a large amount of text data is used.

When the LLM 200a is applied to a communication system that performs a question and answer and a dialogue through linguistic communication or the like with the user U, by inputting text data to the LLM 200a, an answer of the text data is output from the LLM 200a. The information processing device 100 according to the embodiment queries the LLM 200a about the message related to the non-cognitive skills to improve the non-cognitive skills, and transmits the answer from the LLM 200a to the terminal 10.

### <<Generative AI>>

For the foundation model 200, for example, the generative AI may be used. The generative AI includes image generation AI, video generation AI, and voice generation AI.

In a case of applying the image generation AI to the communication system that performs a question and answer, a dialogue, and the like with the user U, when text data is input to the image generation AI, the image generation AI outputs image data. In a case of applying the video generation AI, when text data is input to the video generation AI, the video generation AI outputs video data. At this time, as the database 204, for example, a vector database that stores a large amount of text data, image data, video data, and the like in mathematical representations is used.

In a case in which the voice generation AI is applied in combination with the LLM 200a, when a voice input from the user U is accepted and converted into text data and the text data is input to the LLM 200a, the LLM 200a outputs the text data, and the output text data is converted into voice data and output. At this time, as the database 204, for example, a voice database that includes a large amount of text data and voice data is used. The non-cognitive skills improvement support system 1 can achieve audio communication between the user U and the non-cognitive skills improvement support system 1 by using the voice generation AI.

In this case, the information processing device 100 according to the embodiment queries the generative AI about the message related to the non-cognitive skills to improve the non-cognitive skills, and transmits an answer from the generative AI to the terminal 10.

### <<Multimodal Foundation Model>>

For the foundation model 200, for example, a multimodal foundation model may be used. When the multimodal foundation model is applied to the communication system that performs a question and answer, a dialogue, and the like with the user U, the multimodal foundation model performs at least any of active acquisition of multimodal data on the user U and passive acquisition by accepting an input of multimodal data from the user U, and outputs multimodal data corresponding to the data acquired with these methods.

In this case, the information processing device 100 according to the embodiment queries the multimodal foundation model about the message related to the non-cognitive skills to improve the non-cognitive skills, and transmits an answer from the multimodal foundation model to the terminal 10.

### Terminal 10

The terminal 10 is a device for receiving the message related to the non-cognitive skills to improve the non-cognitive skills from the foundation model 200.

The terminal 10 outputs the received message related to the non-cognitive skills to improve the non-cognitive skills of the user U on the learning screen 50 of the terminal 10 by voice outputting or displaying a balloon and the like during program learning. For example, the terminal 10 may use the character 52 to execute the message output.

The terminal 10 is a Personal Computer (PC) that the user U has, and may be a portable type or a fixed type. The terminal 10 is provided to be able to communicate with the information processing device 100 via the network NW. The information processing device 100 is provided to be able to communicate with the foundation model 200 via the network NW. The communication can be any of wireless or wired communication.

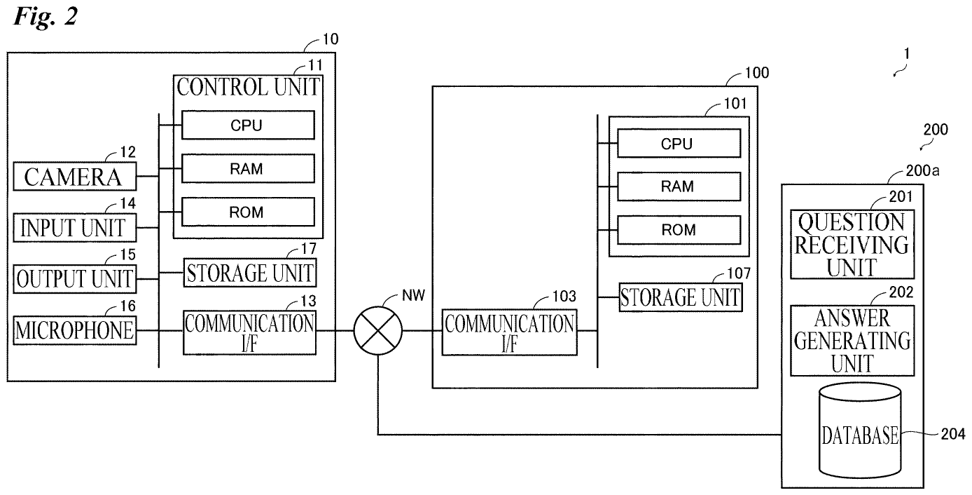

FIG. 2 is a diagram describing the configuration of the non-cognitive skills improvement support system 1 according to Embodiment 1. For example, as illustrated in FIG. 2, the terminal 10 includes a control unit 11, a camera 12, a communication I/F 13, an input unit 14, an output unit 15, a microphone 16, a storage unit 17, and an internal bus that mutually connects the respective units. The control unit 11 includes a Central Processing Unit (CPU), a Random Access Memory (RAM), and a Read Only Memory (ROM).

The camera 12 acquires image data (image information) on the user U's facial expression as biological data (biological information) of the user U (subject). While the image data on the user U's facial expression and the like is described in this example, the biological data is not limited to this, and other kinds of information may be acquired as biological data. For example, information on the user U's pulse wave may be acquired using an infrared camera.

The communication I/F 13 is connected to the network NW, and executes exchanging data (information) with an external device.

The input unit 14 accepts an input of input data (input information) from the user U to the terminal 10. The input unit 14 includes, for example, a publicly known computer mouse and keyboard. For the input unit 14, for example, a voice recognition module is used, and the input unit 14 may convert a voice input from the user U into text data and then accept the input. For example, the input unit 14 may accept an input of voice data of the user U as input data of the user U via the microphone 16 or another publicly known microphone other than the microphone 16.

The output unit 15 outputs the message generated by the information processing device 100 to the user U. The output unit 15 includes a display device, such as a display, that outputs the text data, the image data, the video data, and the like, and a reproduction device, such as a speaker, that outputs the voice data and the like.

For example, the output unit 15 outputs the message together with the character 52 corresponding to the information indicative of the emotion of the user U. In this case, information having a large volume of information and a large influence on the user U's emotion can be output. This allows more efficiently supporting the improvement of the non-cognitive skills of the user U.

For example, the microphone 16 acquires voice data (voice information) of the user U as biological data of the user U. For example, the microphone 16 may acquire the voice data of the user U as input data of the user U.

The storage unit 17 includes various kinds of application program and the like. For example, the storage unit 17 stores an application program that the user U uses for programming learning.

The control unit 11 generates the learning screen 50 for program learning by executing the application program, and displays the learning screen 50 on the display device, such as a display.

The terminal 10 acquires the biological data (for example, image data and voice data) and transmits the biological data to the information processing device 100 via the communication I/F 13. The terminal 10 acquires the input data and transmits the input data to the information processing device 100 via the communication I/F 13. The input data in this example includes, for example, in addition to data on an operation content and the like input through a keyboard, a computer mouse, and the like that the user U uses during the program learning, data on a speech content and the like of the user U input through the microphone 16 and data on the feature quantity and the like of the user U in an image, a moving image, or the like including the expression and the body motion of the user U.

### Information Processing Device 100

The information processing device 100 communicates with the foundation model 200, and receives the message related to the non-cognitive skills to improve the non-cognitive skills of the user U.

For example, as illustrated in FIG. 2, the information processing device 100 includes a control unit 101, a storage unit 107, a communication I/F 103, and an internal bus that mutually connects the respective units. The control unit 101 includes a CPU, a RAM, and a ROM. The communication I/F 103 is connected to the network NW, and executes exchanging data with an external device. The storage unit 107 includes various kinds of application programs and the like. For example, the storage unit 107 stores an application program and the like for supporting the improvement of the non-cognitive skills. The control unit 101 achieves various kinds of processes by executing the application program. The information processing device 100 receives the biological data and the like transmitted from the terminal 10, and generates emotion information of the user U based on the biological data and the like. The information processing device 100 queries the foundation model 200 about the message related to the non-cognitive skills corresponding to the generated emotion information.

The information processing device 100 receives the message related to the non-cognitive skills from the foundation model 200, and transmits it to the terminal 10. The terminal 10 outputs the received message related to the non-cognitive skills to the learning screen 50 of the terminal 10 during the program learning. For example, the terminal 10 may use the character 52 provided on the learning screen 50 to execute the message output. While a configuration in which the foundation model 200 is provided separately from the information processing device 100 is described in this example, the information processing device 100 can be internally provided with a function similar to that of the foundation model 200.

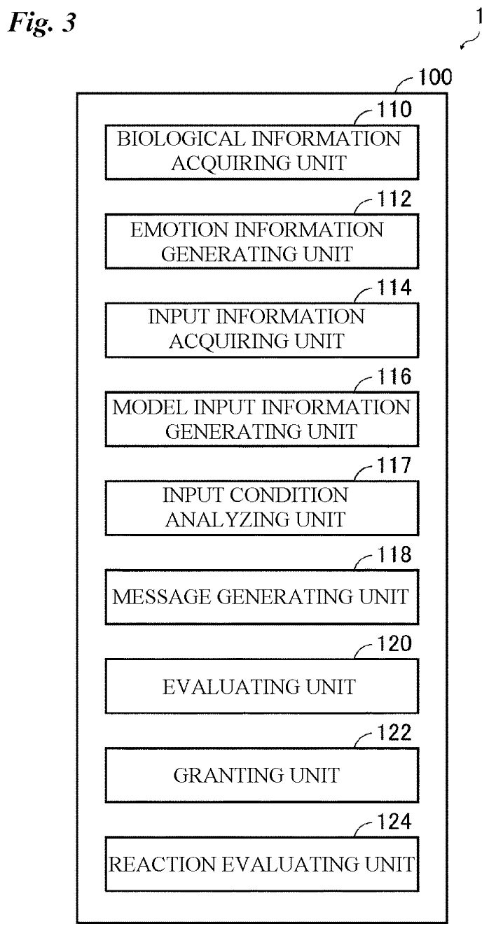

FIG. 3 is a diagram describing the configuration of function blocks of the information processing device 100 according to Embodiment 1. With reference to FIG. 3, the control unit 101 of the information processing device 100 achieves various kinds of function blocks by executing the application programs stored in the storage unit 107.

Specifically, the information processing device 100 includes a biological information acquiring unit 110, an emotion information generating unit (emotion analyzing unit) 112, an input information acquiring unit 114, a model input information generating unit 116, an input condition analyzing unit 117, a message generating unit (output controlling unit) 118, an evaluating unit 120, a granting unit 122, and a reaction evaluating unit 124.

### <<Biological Information Acquiring Unit 110>>

The biological information acquiring unit 110 acquires the biological data (image data, voice data, and the like) that is received via the communication I/F 103 and transmitted from the terminal 10. The acquired biological data is stored in the storage unit 107.

### <<Emotion Information Generating Unit (Emotion Analyzing Unit) 112>>

The emotion information generating unit 112 estimates the emotion (mental state) of the user U based on the acquired biological data (image data, voice data, and the like) and generates the emotion information. The emotion information generating unit 112 estimates (analyzes) the emotion, such as joy, anger, sadness, and excitement, based on the biological data. The emotion information generating unit 112 may estimate calm, surprise, satisfaction, boredom, disappointment, fear, relief, anxiety, and the like as the emotion not limited to the above-described emotions. Specifically, the emotion information generating unit 112 can perform the estimation by processing the eyelid opening, gaze, eyebrow movement, presence or absence of nose wrinkles, mouth movement, mouth opening, pupil opening, and the like included in the facial expression of the user U using the acquired image data. The emotion information generating unit 112 can estimate (analyze) the emotion also with a voice content, a sigh, a breath sound, and the like of the user U using the voice data. The emotion information generating unit 112 may estimate the emotion using only any one piece of the data, or may estimate the emotion using a combination of the data.

### <<Input Information Acquiring Unit 114>>

The input information acquiring unit 114 acquires the input data (input information) that is received via the communication I/F 103 and transmitted from the terminal 10. The input data acquired by the input information acquiring unit 114 is stored in the storage unit 107.

Here, the input data (input information) includes the content of data input to the non-cognitive skills improvement support system 1 by the user U and the feature quantities of the input, such as an input speed and the number of input errors.

For example, the input information acquiring unit 114 may acquire text data acquired via the keyboard connected to the terminal 10 as the input data, may acquire text data or voice data acquired via the microphone 16 as the input data, and may acquire text data, voice data, image data, or video data acquired via the camera 12 as the input data.

### <<Model Input Information Generating Unit 116>>

The model input information generating unit 116 generates model input information using the message related to the non-cognitive skills corresponding to the emotion information generated by the emotion information generating unit 112 as data (information) input to the foundation model 200. For example, the model input information generating unit 116 inputs the generated data to the foundation model 200.

The data input to the foundation model 200 includes any of the above-described text data, voice data, image data, video data, and sensor data, or the multimodal data. The data input to the foundation model 200 is data including meanings of an instruction, a command, a query, and the like to the foundation model 200, and may include a prompt or a query as the text data.

Here, when the LLM 200a is applied to the foundation model 200, the model input information generating unit 116 generates a prompt as the model input information. In this case, since the model input information and the message related to the non-cognitive skills are reliably acquired as language information, the user U easily understands the message. This allows an attempt to enhance the convenience of the user U.

For example, the model input information generating unit 116 generates data (information) input to the foundation model 200 to make a query about the message related to the non-cognitive skills corresponding to the emotion information generated by the emotion information generating unit 112.

That is, the model input information generating unit 116 generates the model input information to be input to the foundation model 200 based on the emotion information generated by the emotion information generating unit 112 and the input information acquired by the input information acquiring unit 114. In this case, an output content and an output timing of an empathetic message that aligns with the emotion of the user U can be optimized depending on the input content, the input status, and the like of the user U. This allows more efficiently supporting the improvement of the non-cognitive skills of the user U.

The model input information generating unit 116 may generate the model input information to be input to the foundation model 200 based on the emotion information generated by the emotion information generating unit 112 and input condition information that is generated by the input condition analyzing unit 117 based on the input information acquired by the input information acquiring unit 114. In this case, the output content and the output timing of the empathetic message that aligns with the emotion of the user U can be optimized depending on the input proficiency level, the concentration level, and the like of the user U. This allows more efficiently supporting the improvement of the non-cognitive skills of the user U.

For example, the model input information generating unit 116 may perform the generation with a method of acquiring the data input to the foundation model 200 to make the query about the message related to the non-cognitive skills corresponding to the emotion information generated by the emotion information generating unit 112 by referring to a preliminarily stored database including a plurality of data sets of the emotion information as an input and the model input information as an output.

Further, for example, the model input information generating unit 116 may perform the generation with a method of outputting the data input to the foundation model 200 to make the query about the message related to the non-cognitive skills corresponding to the emotion information generated by the emotion information generating unit 112 by inputting the emotion information to a learning model preliminarily trained using a learning data set of the emotion information as an input and the model input information as an output.

### <<Input Condition Analyzing Unit 117>>

The input condition analyzing unit 117 analyzes the input condition of the user U based on the acquired input data. Specifically, the input condition analyzing unit 117 analyzes the input speed, the number of input errors, and the like of the input data by the user U, and estimates the input condition of the user U.

### <<Message Generating Unit (Output Controlling Unit) 118>>

The message generating unit 118 generates a message to improve the non-cognitive skills including a message empathetic toward the user U based on the information generated by the model input information generating unit 116. For example, the message generating unit 118 generates the message based on the information output from the foundation model 200 to which the information generated by the model input information generating unit 116 has been input. For example, the message generating unit 118 may input the information generated by the model input information generating unit 116 to the foundation model 200 instead of the input by the model input information generating unit 116.

The message generating unit 118 outputs information on an answer and the like from the foundation model 200 to the terminal 10. For example, the message generating unit 118 outputs the message generated by the message generating unit 118 based on the information on the answer and the like from the foundation model 200 to the terminal 10.

### <<Evaluating Unit 120>>

The evaluating unit 120 evaluates an effort level of the user U for a task. The task of the user U is, for example, the program learning. Details of the evaluation will be described below.

### <<Granting Unit 122>>

The granting unit 122 provides a reward to the user U based on an evaluation result by the evaluating unit 120. The reward is, for example, a point usable in a service of a charging system when the service is set in the non-cognitive skills improvement support system 1. In this case, separately from the communication with the non-cognitive skills improvement support system 1, the further improvement of the non-cognitive skills of the user U can be promoted. This allows more efficiently supporting the improvement of the non-cognitive skills of the user U.

### <<Reaction Evaluating Unit 124>>

The reaction evaluating unit 124 evaluates the reaction of the user U to the output of the message related to the non-cognitive skills to improve the non-cognitive skills of the user U. The reaction evaluating unit 124 adjusts various kinds of parameters based on an evaluation result of the reaction of the user U.

The reaction evaluating unit 124 adjusts the parameters based on the emotion information generated by the emotion information generating unit 112. For example, when a positive emotion, such as joy and excitement, is estimated based on the emotion information, the reaction evaluating unit 124 increases an output frequency of the message related to the non-cognitive skills. Meanwhile, when a negative emotion, such as anger and sadness, is estimated based on the emotion information, the reaction evaluating unit 124 increases a length of a predetermined period to decrease the output frequency of the message related to the non-cognitive skills.

For example, the reaction evaluating unit 124 evaluates the reaction of the user U after the message is output. In this case, the empathetic message that aligns with the emotion of the user U can be output to the user U corresponding to the emotional change of the user U through the communication with the non-cognitive skills improvement support system 1. This allows more efficiently supporting the improvement of the non-cognitive skills of the user U.

### Embodiment 1: Operation Method of Non-Cognitive Skills Improvement Support System 1

Next, with reference to the drawings, an exemplary operation of the non-cognitive skills improvement support system 1 is described as a non-cognitive skills improvement support method according to Embodiment 1. The operation of the non-cognitive skills improvement support system 1 includes, for example, an emotion information generating step, a model input information generating step, a message generating step, and an output step.

### Emotion Information Generating Step

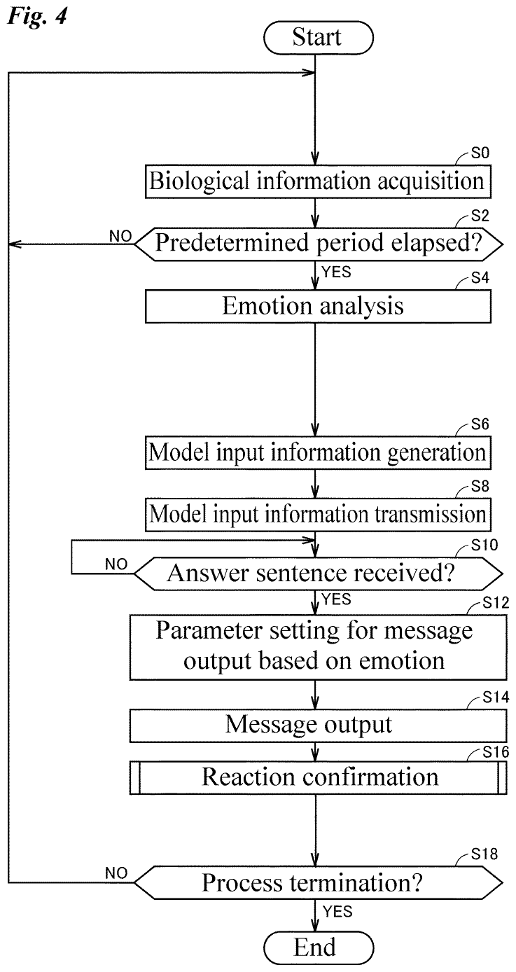

FIG. 4 is a flowchart describing the process of the information processing device 100 according to Embodiment 1. With reference to FIG. 4, the information processing device 100 acquires the biological data (biological information) of the user U in the emotion information generating step (Step S0). Specifically, the biological information acquiring unit 110 acquires the biological data transmitted from the terminal 10. Here, the biological data of the user U is preliminarily acquired by the respective configurations (the camera 12, the input unit 14, the microphone 16, and the like) of the terminal 10 before Step S0.

Next, the information processing device 100 determines whether or not a predetermined period has elapsed (Step S2). When it is determined that the predetermined period has not elapsed (NO in Step S2), the information processing device 100 returns to Step SO and repeats the above-described process. While the predetermined period can be set to any period, the predetermined period can be set to, for example, five minutes.

When it is determined that the predetermined period has elapsed (YES in Step S2), the information processing device 100 proceeds to the next process.

The information processing device 100 executes a process of analyzing the emotion (Step S4). Specifically, the emotion information generating unit 112 estimates the emotion (mental state) of the user U based on the biological data (image data, voice data, and the like) stored in the storage unit 107 after the elapse of the predetermined period, and generates the emotion information. Part of the data in the biological data (image data, voice data, and the like) stored in the storage unit 107 in the predetermined period may be used, or the whole of the data may be used.

The information processing device 100 may terminate the emotion information generating step, for example, when the emotion information is generated.

### Model Input Information Generating Step

Next, the information processing device 100 generates the model input information to be transmitted to the foundation model 200 in the model input information generating step (Step S6). Specifically, the model input information generating unit 116 generates the data for inputting the message related to the non-cognitive skills corresponding to the emotion information generated by the emotion information generating unit 112 to the foundation model 200.

Next, the information processing device 100 transmits the generated model input information to the foundation model 200 (Step S8). Specifically, the model input information generating unit 116 transmits the generated model input information that is data input to the foundation model 200.

For example, when the model input information is generated, when the model input information is transmitted to the foundation model 200, or when the model input information is input to the foundation model 200, the information processing device 100 terminates the model input information generating step.

### Message Generating Step

Next, the information processing device 100 determines whether or not an answer sentence has been received from the foundation model 200 in the message generating step (Step S10). Specifically, the message generating unit 118 determines whether or not an answer sentence has been received from the foundation model 200.

In Step S10, the information processing device 100 maintains the state until the answer sentence is received from the foundation model 200.

For example, when the answer sentence is received from the foundation model 200 (YES in Step S10), the information processing device 100 may set a parameter for outputting a message of the answer sentence based on the emotion information (Step S12). Specifically, for example, the message generating unit 118 may set a parameter for outputting a message of the answer sentence based on the emotion information. Details of the setting of the parameter for outputting the message will be described below.

For example, when the answer sentence is received from the foundation model 200, or when the content, the format, and the like of the output are adjusted according to a preset format for the answer sentence received from the foundation model 200, the information processing device 100 terminates the message generating step.

### Output Step

Next, the information processing device 100 outputs information on the message output to the terminal 10 (Step S14). Specifically, the message generating unit 118 transmits information on the message output including the message of the answer sentence to the terminal 10. When a plurality of answer sentences are received from the foundation model 200, the message generating unit 118 may select one of the plurality of answer sentences. When a plurality of answer sentences are received, the message generating unit 118 may generate the message of the answer sentence by appropriately combining the plurality of answer sentences or extracting only a necessary part and appropriately processing and editing it.

When the message including the answer sentence is input from the information processing device 100, the terminal 10 outputs the input message to the user U via the output unit 15. In this case, continuous communication with a content empathetic toward the emotion of the user U can be achieved with the user U through an answer corresponding to the information indicative of the emotion of the user U. This allows efficiently supporting the improvement of the non-cognitive skills of the user U.

That is, the operation of the non-cognitive skills improvement support system 1 includes the emotion information generating step of generating the emotion information based on the biological information of the user U, the model input information generating step of generating the model input information to be input to the foundation model 200 based on the emotion information generated in the emotion information generating step, the message generating step of generating the message to improve the non-cognitive skills including the message empathetic toward the user U based on the model input information generated in the model input information generating step, and the output step of outputting the message generated in the message generating step to the user U. In this case, the empathetic message that aligns with the emotion of the user U can be output to the user U. This allows efficiently supporting the improvement of the non-cognitive skills of the user U.

For example, when the message to the user U is output, the information processing device 100 and the terminal 10 may terminate the output step.

### Post-Process of Output Step

Next, the information processing device 100 may execute a process of confirming the reaction of the user U (reaction confirmation process) (Step S16).

Specifically, for example, the information processing device 100 may execute a process of confirming the reaction of the user U to the message output. Details of the process will be described in <Details of Reaction Confirmation Process>below.

Next, the information processing device 100 determines whether to terminate the process for supporting the improvement of the non-cognitive skills or not (Step S18).

In Step S18, the information processing device 100 terminates the process when it is determined to terminate the process for supporting the improvement of the non-cognitive skills (End). Specifically, the information processing device 100 terminates the process when the terminal 10 determines that the user U has terminated the application program for the programming learning. For example, the information processing device 100 may terminate the process when a command to terminate the application program for the programming learning is received from the terminal 10.

Meanwhile, in Step S18, when it is determined not to terminate the process for supporting the improvement of the non-cognitive skills (NO in Step S18), the information processing device 100 returns to Step SO and repeats the above-described process.

By executing the above-described steps, the operation of the non-cognitive skills improvement support system 1 ends. In the operation of the non-cognitive skills improvement support system 1, the execution of the setting of the parameter for outputting the message (Step S12) and the reaction confirmation process (Step S16) may be omitted.

### Details of Reaction Confirmation Process (Reaction Evaluating Step)

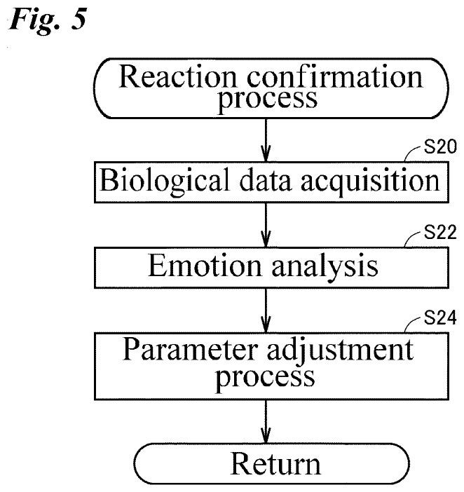

FIG. 5 is a diagram describing a subroutine flow of the reaction confirmation process (reaction evaluating step) according to Embodiment 1. With reference to FIG. 5, the information processing device 100 acquires the biological data from the terminal 10 after the message output (Step S20). Specifically, the biological information acquiring unit 110 acquires the biological data transmitted from the terminal 10 after the message output.

Next, the information processing device 100 executes a process of analyzing the emotion (Step S22). Specifically, the emotion information generating unit 112 estimates the emotion (mental state) of the user U based on the biological data (image data, voice data, and the like) stored in the storage unit 107 after the message output, and generates the emotion information. The emotion information generating unit 112 may additionally acquire the biological data of the user U who has reacted to the message or the user U who has replied to the message after the message output, then estimate the emotion (mental state) of the user U based on the additionally acquired biological data, and generate the emotion information.

Next, the information processing device 100 executes a process of adjusting the parameter (Step S24). The reaction evaluating unit 124 executes the process of adjusting the parameter based on the emotion information generated by the emotion information generating unit 112. In this example, the reaction evaluating unit 124 adjusts the length of the predetermined period of the process in Step S2 based on the generated emotion information. For example, when a positive emotion, such as joy and excitement, is estimated based on the emotion information, the reaction evaluating unit 124 decreases the length of the predetermined period to increase the output frequency of the message related to the non-cognitive skills. Meanwhile, when a negative emotion, such as anger and sadness, is estimated based on the emotion information, the reaction evaluating unit 124 increases the length of the predetermined period to decrease the output frequency of the message related to the non-cognitive skills. Adjusting the output frequency of the message according to the emotional state of the user U allows supporting the improvement of the non-cognitive skills. Note that, for example, the reaction evaluating unit 124 may be configured to execute only the process of decreasing the length of the predetermined period when a positive emotion, such as joy and excitement, is estimated based on the emotion information, and not to change the length of the predetermined period when a negative emotion, such as anger and sadness, is estimated based on the emotion information, or may be configured to execute the opposite processes.

Then, the information processing device 100 terminates the reaction confirmation process (Return).

### Exemplary Model Input Information and Answer When LLM 200a Is Used

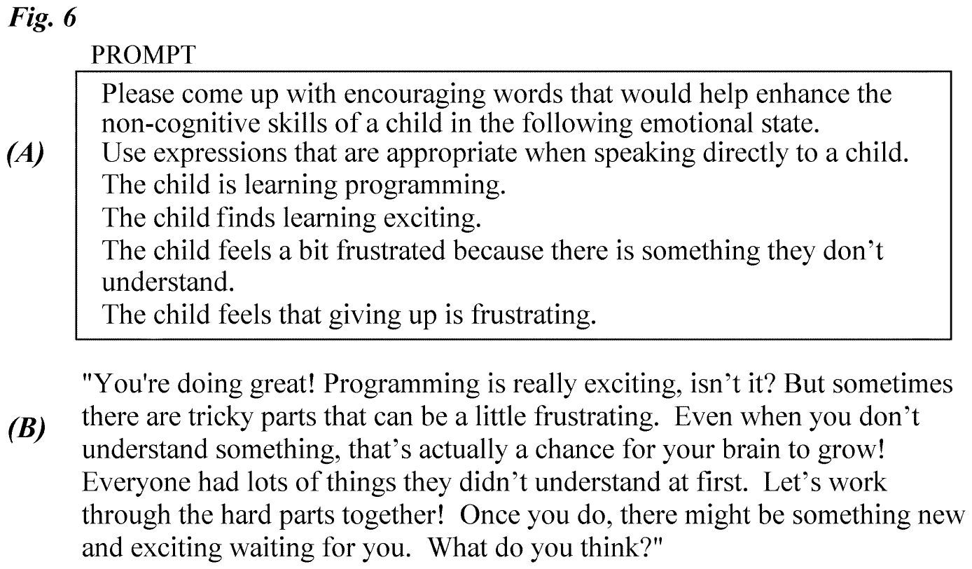

FIG. 6 is a diagram describing exemplary model input information and answer according to Embodiment 1. While the following describes an example of using the LLM 200a, it is needless to say that the similar content may be applied to the model input information for the generative AI and the multimodal foundation model. FIG. 6(A) indicates a prompt as text data that is generated by the model input information generating unit 116 based on the emotion information and to be transmitted to the LLM 200a.

For example, the model input information generating unit 116 generates a prompt below based on the emotion information (“excitement”). Specifically, for example, the model input information generating unit 116 generates the following texts. “(A) Please come up with encouraging words that would help enhance the non-cognitive skills of a child in the following emotional state. Use expressions that are appropriate when speaking directly to a child. The child is learning programming. (B) The child finds learning exciting. (C) The child feels a bit frustrated because there is something they don't understand. (D) The child feels that giving up is frustrating.” Here, the “child” in the text (A) is based on, for example, the physical attribute information of the user U preliminarily stored in each configuration of the non-cognitive skills improvement support system 1 or the physical attribute information of the user U acquired by the input unit 14. “Learning programming” is based on, for example, the user U's purpose of using the non-cognitive skills improvement support system 1 preliminarily stored in each configuration of the non-cognitive skills improvement support system 1 or operation information on the non-cognitive skills improvement support system 1 of the user U acquired by the input unit 14. “Please come up with encouraging words that would help enhance the non-cognitive skills” is intended to generate a message to improve the non-cognitive skills including a message empathetic toward the user U.

The information indicative of the emotion, such as “exciting,” “frustrated,” and “frustrating,” in the texts (B), (C), and (D) is based on, for example, the emotion information of the user U generated by the emotion information generating unit 112.

FIG. 6(B) indicates an exemplary answer text to the above-described prompt from the LLM 200a. For example, the information processing device 100 receives the following answer text. “You're doing great! Programming is really exciting, isn't it? But sometimes there are tricky parts that can be a little frustrating. Even when you don't understand something, that's actually a chance for your brain to grow! Everyone had lots of things they didn't understand at first. Let's work through the hard parts together! Once you do, there might be something new and exciting waiting for you.”

The information processing device 100 transmits the received answer text to the terminal 10.

The terminal 10 outputs the learning screen 50 for the program learning and the message related to the non-cognitive skills to improve the non-cognitive skills of the user U as the answer text transmitted from the information processing device 100. Through this process, the non-cognitive skills improvement support system 1 can improve and enhance the non-cognitive skills of the user U by analyzing the emotional state of the user U and outputting the empathetic message that aligns with the analyzed emotion information to the user U. That is, the non-cognitive skills improvement support system 1 can appropriately grasp the state of the user U as the subject, and can efficiently support the improvement of the non-cognitive skills.

### Example of Prompt Generation

In the above description, the case in which the model input information generating unit 116 generates the prompt based on the emotion information (“excitement”) has been described. The model input information generating unit 116 can generate a prompt similarly based on the other emotion information.

For example, the model input information generating unit 116 generates a prompt based on the emotion information (“anger”). For example, the model input information generating unit 116 may change the text (B) among the texts (A) to (D) as the prompt to the following text. “The child feels angry about learning.” The model input information generating unit 116 may fix the text (A) and change the texts (B) to (D) based on the emotion information as necessary. For example, the information processing device 100 receives the following answer text to the prompt. “Anger is an emotion that arises when you're learning something new. If you keep moving forward step by step, that anger will gradually fade away. Don't overlook your own growth.” The information processing device 100 transmits the received answer text to the terminal 10.

For example, the model input information generating unit 116 generates a prompt based on the emotion information (“sadness”). For example, the model input information generating unit 116 may change the text (B) among the texts (A) to (D) as the prompt to the following text. “The child feels sad about learning.” The model input information generating unit 116 may fix the text (A) and change the texts (B) to (D) based on the emotion information as necessary. For example, the information processing device 100 receives the following answer text to the prompt. “Try to see sadness as a step toward growth. It's natural not to understand everything, but what's important is the attitude of doing your best to overcome it.” The information processing device 100 transmits the received answer text to the terminal 10.

For example, the model input information generating unit 116 generates a prompt based on the emotion information (“joy”). For example, the model input information generating unit 116 may change the text (B) among the texts (A) to (D) as the prompt to the following text. “The child feels joyful about learning.” The model input information generating unit 116 may fix the text (A) and change the texts (B) to (D) based on the emotion information as necessary. For example, the information processing device 100 receives the following answer text to the prompt. “Your motivation to learn is wonderful. By moving forward with a sense of joy, you can continue to grow more and more.” The information processing device 100 transmits the received answer text to the terminal 10.

### Setting of Parameter for Message Output

The message generating unit 118 sets the parameter for outputting the message of the answer sentence based on the emotion information. For example, the message generating unit 118 may set a parameter of a color for the message output based on the emotion information. For example, the message generating unit 118 may set parameters of text colors, such as orange, red, blue, and yellow, based on the emotion information of “joy,” “anger,” “sadness,” and “excitement” to output the message. By outputting the message utilizing a psychological effect of colors, the message generating unit 118 can improve and enhance the non-cognitive skills through the output of the empathetic message that aligns with the analyzed emotion information to the user U via the colors. That is, the state of the user U as the subject can be appropriately grasped, and the improvement of the non-cognitive skills can be efficiently supported. The setting of the parameters of the text colors is an example and not limited thereto, the parameters can be set to other colors, and the message may be output with brightness and another parameter changed based on the emotion information.

The message generating unit 118 may adjust the movement of the character 52 based on the emotion information when the message is output using the character 52. For example, a plurality of patterns of the movement of the character 52 may be prepared in advance, and the message generating unit 118 may select one of the plurality of patterns of the movement based on the emotion information and cause the terminal 10 to perform a display. For example, the patterns of the movement corresponding to “joy,” “anger,” “sadness,” and “excitement” may be prepared in advance, and the message generating unit 118 may set the parameter so as to have the pattern corresponding to the emotion information among the plurality of patterns of the movement when setting the parameter for the message output. For example, by displaying the movement of the character 52 corresponding to the emotion information when outputting the message, the non-cognitive skills improvement support system 1 can improve and enhance the non-cognitive skills through the output of the empathetic message that aligns with the analyzed emotion information to the user U together with the movement of the character 52. That is, the non-cognitive skills improvement support system 1 can appropriately grasp the state of the user U as the subject, and can efficiently support the improvement of the non-cognitive skills.

When the message is output using the character 52, the terminal 10 may use a balloon display to make the character 52 appear to be speaking, or may output the message by voice.

The message generating unit 118 may adjust the pattern of the message output by voice based on the emotion information. For example, a plurality of voice output patterns may be prepared in advance, and the message generating unit 118 may select one of the plurality of voice output patterns based on the emotion information and output the selected one. For example, the voice output patterns corresponding to “joy,” “anger,” “sadness,” and “excitement” may be prepared in advance, and the message generating unit 118 may set the parameter so as to have the pattern corresponding to the emotion information among the plurality of voice output patterns when setting the parameter for the message output by voice. For example, by outputting the voice output pattern corresponding to the emotion information when outputting the message by voice, the non-cognitive skills improvement support system 1 can improve and enhance the non-cognitive skills through the output of the empathetic voice message that aligns with the analyzed emotion information to the user U. That is, the non-cognitive skills improvement support system 1 can appropriately grasp the state of the user U as the subject, and can efficiently support the improvement of the non-cognitive skills.

The message generating unit 118 may use any of the parameter setting methods alone, or may use the parameter setting methods in combination. For the information processing device 100, while the method of executing the process of setting the parameter for the message output based on the emotion information in Step S12 has been described in the process flow of FIG. 4, this method is not a required configuration, and a method without the setting process can be employed. For the information processing device 100, while the method of executing the reaction confirmation process in Step S16 has been described in the process flow of FIG. 4, this method is not a required configuration, and a method without the reaction confirmation process can be employed.

### Embodiment 2: Operation Method of Non-Cognitive Skills Improvement Support System 1

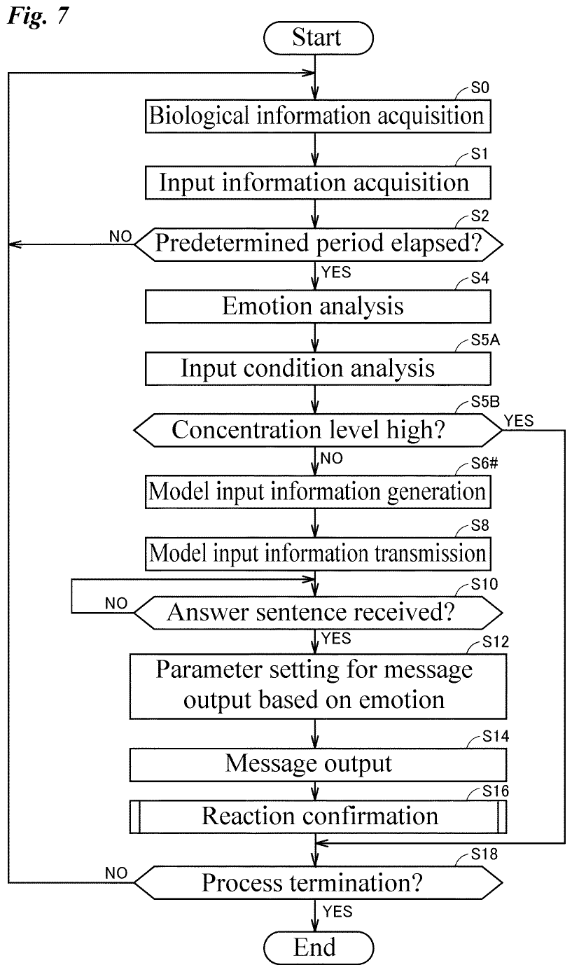

FIG. 7 is a flowchart describing the process of an information processing device 100 according to Embodiment 2. With reference to FIG. 7, the process of the information processing device 100 according to Embodiment 2 is different from the flowchart of FIG. 4 in that Steps S1, S5A, and S5B are added and Step S6 is substituted with Step S6 #. Since the other configurations are similar to those in the above description, the detailed description is not repeated.

The operation of the non-cognitive skills improvement support system 1 further includes, for example, an input information acquiring step. The operation of the non-cognitive skills improvement support system 1 may further include, for example, an input condition analyzing step.

### Input Information Acquiring Step

The information processing device 100 acquires the biological data in Step SO, and then acquires input data in the input information acquiring step (Step S1).

Specifically, the input information acquiring unit 114 acquires the input data (input information) of the user U transmitted from the terminal 10. Here, the input data of the user U is preliminarily acquired by the respective configurations (the camera 12, the input unit 14, the microphone 16, and the like) of the terminal 10 before Step SO.

Next, the information processing device 100 determines whether or not a predetermined period has elapsed (Step S2). When it is determined that the predetermined period has not elapsed (NO in Step S2), the information processing device 100 returns to Step SO and repeats the above-described process. While the predetermined period can be set to any period, the predetermined period can be set to, for example, five minutes.

When it is determined that the predetermined period has elapsed (YES in Step S2), the information processing device 100 proceeds to the next process.

### Input Condition Analyzing Step

After executing the process of analyzing the emotion after the elapse of the predetermined period in Step S4, the information processing device 100 may execute an analysis process of the input condition in the input condition analyzing step (Step S5A). Specifically, the input condition analyzing unit 117 analyzes the input condition of the user U based on the input data stored in the storage unit 107. The input condition analyzing unit 117 may use part of the data in the input data stored in the storage unit 107 in the predetermined period, or may use the whole of the data.

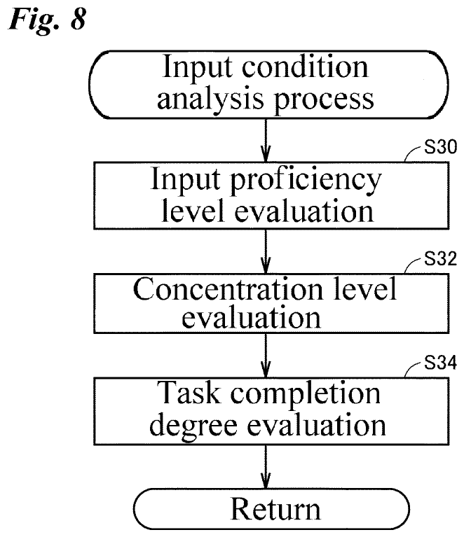

FIG. 8 is a flowchart describing the analysis process of the input condition according to Embodiment 2. With reference to FIG. 8, the input condition analyzing unit 117 evaluates an input proficiency level based on the acquired input data (Step S30). Specifically, the input condition analyzing unit 117 analyzes the input speed, the number of input errors, and the like of the user U who uses a keyboard or the like, and estimates the input proficiency level of the user U as information on the input data.

The input condition analyzing unit 117 may estimate the input proficiency level and classify it as a high or low level, and may further classify the input proficiency level into a plurality of levels. The information on the input proficiency level can be used for the generation of the prompt in this example.

Next, the input condition analyzing unit 117 evaluates a concentration level based on the acquired input data (Step S32). Specifically, the input condition analyzing unit 117 analyzes the length of an input period and the like of the user U who uses a keyboard or the like, and evaluate the concentration level of the user U as information on the input data.

For example, the input condition analyzing unit 117 can estimate the concentration level of the user U to be high when the length of the input period during a specific period is long. When the input period during the specific period is equal to or more than a certain threshold, the input condition analyzing unit 117 may estimate the concentration level to be high, and may estimate the concentration level not to be high in the other case.

Next, the input condition analyzing unit 117 evaluates a task completion degree based on the acquired input data (Step S34). Specifically, the input condition analyzing unit 117 evaluates a completion degree of the programming learning provided as a task based on the input data as information on the input data. Specifically, the input condition analyzing unit 117 may evaluate the completion degree of the programming learning by comparing correct answer information of the programming learning provided as a task with input information input by the user U at present.

Although described later, the evaluating unit 120 evaluates the effort level for the task based on the information on the completion degree of the programming learning. The evaluating unit 120 may evaluate the effort level also taking the input period and the input proficiency level of the programming learning into consideration. Then, the input condition analyzing unit 117 terminates the analysis process of the input condition (Return).

With reference to FIG. 7 again, the information processing device 100 determines whether or not the concentration level is high as the analyzed input condition information (Step S5B). Specifically, the model input information generating unit 116 determines whether or not the concentration level is high as an analysis result by the input condition analyzing unit 117.

In Step S5B, when it is determined that the concentration level is not high as the analyzed input condition (NO in Step S5B), the information processing device 100 terminates an input information analyzing step, and proceeds to a model input information generating step (Step S6 #).

### Model Input Information Generating Step

Next, the information processing device 100 generates the model input information to be transmitted to the foundation model 200 (Step S6 #). Specifically, when it is determined that the concentration level is not high as the analysis result by the input condition analyzing unit 117, the model input information generating unit 116 generates data that corresponds to the emotion information generated by the emotion information generating unit 112 and the information on the input proficiency level, is related to the non-cognitive skills, and is to be input to the foundation model 200. Specifically, the model input information generating unit 116 includes a text related to the input proficiency level when generating the model input information based on the emotion information. For example, the model input information generating unit 116 can include a text, such as “(E) the input proficiency level is high” or “(E) the input proficiency level is low,” as information on the input condition of the user U, in addition to the texts (A) to (D) described in FIG. 6. The following processes are similar to those described in the flowchart of FIG. 4.

That is, the operation of the non-cognitive skills improvement support system 1 includes the model input information generating step of generating the model input information to be input to the foundation model 200 based on the emotion information generated in the emotion information generating step and the input information acquired in the input information acquiring step. In this case, the output content and the output timing of the empathetic message that aligns with the emotion of the user U can be optimized depending on the input content, the input status, and the like of the user U. This allows more efficiently supporting the improvement of the non-cognitive skills of the user U.

Meanwhile, when it is determined that the concentration level is high as the analyzed input condition (YES in Step S5B) in Step S5B, the information processing device 100 skips Step S6 #to Step S16 and proceeds to Step S18. Specifically, when it is determined that the concentration level is high as the analysis result by the input condition analyzing unit 117, the model input information generating unit 116 does not execute the prompt generation process. That is, when the concentration level is high, the information processing device 100 does not output the message to the terminal 10. The information processing device 100 evaluates the concentration level based on the acquired input data, and does not output the message when the concentration level is estimated to be high.

The message output when the concentration level is high possibly disturbs the user U's thinking. Therefore, in this state, the non-cognitive skills improvement support system 1 stops the message output, thereby allowing the improvement and enhancement of the non-cognitive skills. That is, the non-cognitive skills improvement support system 1 can appropriately grasp the state of the user U as the subject, and can efficiently support the improvement of the non-cognitive skills.

While the case in which the concentration level is determined based on the input data has been described in this example, it is not limited thereto, and the input condition analyzing unit 117 may determine the concentration level in combination with the emotion information. While the method of determining whether or not the message can be output based on the concentration level of the user U has been described in this example, the non-cognitive skills improvement support system 1 may adjust the output frequency of the message related to the non-cognitive skills based on the concentration level of the user U. For example, the non-cognitive skills improvement support system 1 may increase the length of the predetermined period in the process of Step S2 when the concentration level of the user U is high. The non-cognitive skills improvement support system 1 adjusts the output frequency of the message corresponding to the concentration level of the user U, thereby allowing supporting the improvement of the non-cognitive skills.

By executing the above-described steps, the operation of the non-cognitive skills improvement support system 1 ends.

In the operation of the non-cognitive skills improvement support system 1, the execution of the input information analyzing step (Step S5A, Step S5B) may be omitted. At this time, the model input information generating unit 116 may generate multimodal data related to (A) to (D) described in FIG. 6 based on the content of “exciting,” “frustrated,” “frustrating,” and the like included in the input data of the user U without analyzing the input data of the user U in the model input information generating step.

### Rewarding

The evaluating unit 120 evaluates the effort level of the user U for the program learning as the task. The evaluating unit 120 evaluates the effort level based on the task completion degree analyzed by the input condition analyzing unit 117. The evaluating unit 120 may evaluate the effort level also taking the input period and the input proficiency level of the programming learning into consideration.

For example, the evaluating unit 120 classifies the effort level of the user U for the programming learning into a plurality of states. For example, when the effort level of the user U is very excellent, the evaluating unit 120 classifies the effort level of the user U as “excellent.” The evaluating unit 120 may perform the classification as “excellent” when the task completion degree is “100%.” When the effort level of the user U is relatively good, the evaluating unit 120 classifies the effort level of the user U as “good.” The evaluating unit 120 may perform the classification as “good” when the task completion degree is “90% or more.” When the effort level of the user U is normal, the evaluating unit 120 classifies the effort level of the user U as “fair.” The evaluating unit 120 may perform the classification as “fair” when the task completion degree is “less than 90%.” While the case of the classification into three levels is described in this example, the classification into further multiple levels may be performed.

For example, the granting unit 122 gives a reward (for example, a point) to the evaluated user U classified as “excellent” in the effort level for the programming learning.

For the reward (point), when a charging system is set for using a service in the programming learning, the service may be available using part of or all of the reward (point). Alternatively, for example, the reward (point) may be usable for purchasing an item (clothes, a hat, and the like) of the character 52 or displaying another character.

The non-cognitive skills improvement support system 1 gives the reward when the user U is classified as “excellent” indicating a very excellent effort level for the learning as the state of the subject, thereby allowing the improvement and enhancement of the non-cognitive skills. That is, the non-cognitive skills improvement support system 1 can appropriately grasp the state of the user U as the subject, and can efficiently support the improvement of the non-cognitive skills.

The reward (point) that the non-cognitive skills improvement support system gives is not limited to the point, and may be an item and the like, and for example, the reward may be a system provided by an affiliated company (a cooperative company and a supporting company) and the like of the non-cognitive skills improvement support system.

### Embodiment 3: Non-Cognitive Skills Improvement Support System 1

A non-cognitive skills improvement support system 1 according to Embodiment 3 is different from the above-described embodiments in that the non-cognitive skills improvement support system 1 is applied to a user U other than a learner. Since the other configurations are similar to those in the above description, the detailed description is not repeated.

### User U Requesting Personal Assistant

The user U is a person who uses the non-cognitive skills improvement support system 1 as a personal assistant.

The user U speaks to the non-cognitive skills improvement support system 1, thereby generating input data via the model input information generating unit 116 and inputting the input data to the foundation model 200. Then, the non-cognitive skills improvement support system 1 generates a message to improve the non-cognitive skills of the user U via the message generating unit 118, and outputs the message to the user U via the output unit 15.

For example, when the concentration level of the user U is low, or when it is determined that the emotion of the user U is negative, the non-cognitive skills improvement support system 1 may generate the model input information based on the emotion information of the user U without waiting for the user U to speak, generate the message based on the model input information, and then output the message to the user U via the output unit 15. In this case, bidirectional communication can be achieved compared with a case in which the speaking of the user U is a trigger for the message output. This allows more efficiently supporting the improvement of the non-cognitive skills of the user U.

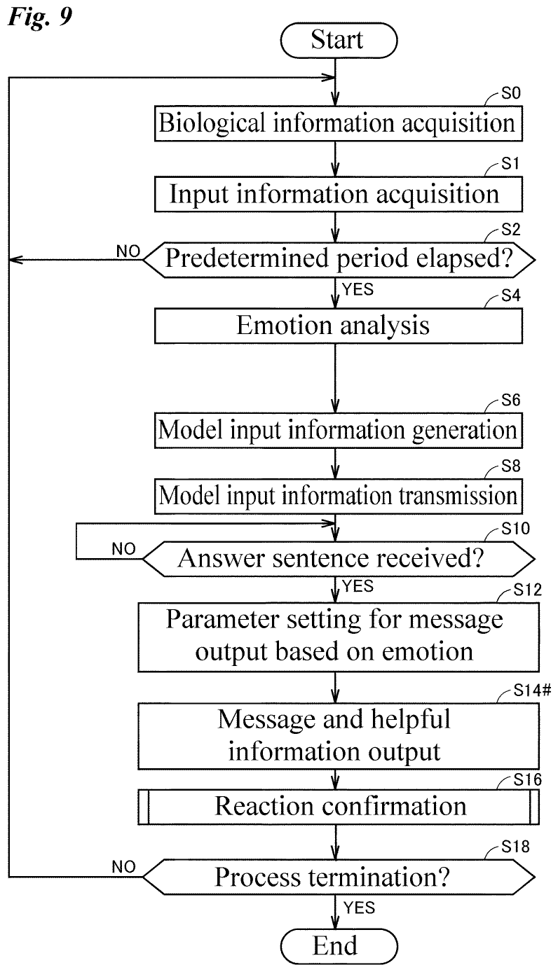

For example, as illustrated in FIG. 9, the non-cognitive skills improvement support system 1 further generates helpful information to improve the non-cognitive skills of the user U based on the information output from the foundation model 200 to which the information generated by the model input information generating unit 116 has been input via the message generating unit 118. Then, for example, the non-cognitive skills improvement support system 1 outputs the message and the helpful information to the user U via the output unit 15 (Step S14 #). In this case, an empathetic answer that aligns with the emotion of the user U can be provided with a higher information volume than that of the message alone. This allows more efficiently supporting the improvement of the non-cognitive skills of the user U.

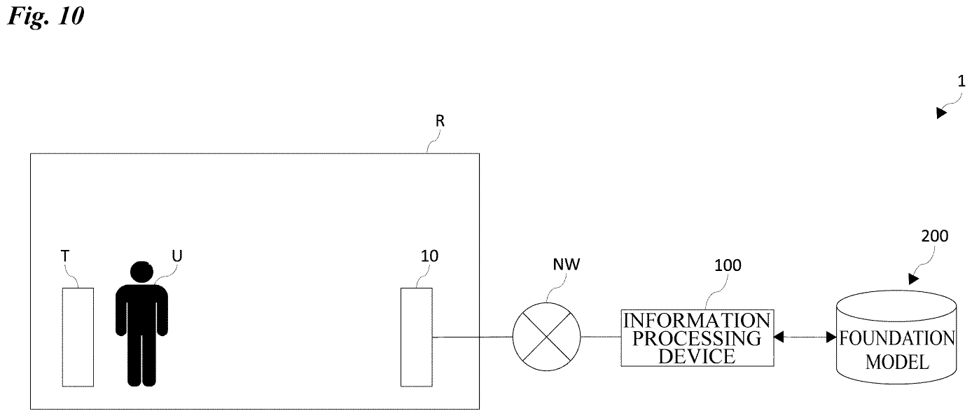

For example, as illustrated in FIG. 10, the non-cognitive skills improvement support system 1 may generate the emotion information based on the biological information of the user U who does not perform the input to the terminal 10 (device) via the emotion information generating unit 112, and may output the message by voice to the user U via the output unit 15. That is, for example, the user U can use the non-cognitive skills improvement support system 1 even when performing work using an object T at a position apart from the terminal 10. In this case, the empathetic answer that aligns with the emotion of the user U can be provided to a wider variety of users U. This allows more efficiently supporting the improvement of the non-cognitive skills of the user U. Since the input through the terminal 10 is not required, one-to-many communication between one non-cognitive skills improvement support system 1 and a plurality of users U can be achieved. This allows more efficiently supporting the improvement of the non-cognitive skills of the user U.

FIG. 10 illustrates an example in which the user U is working using a device, papers, or the like different from the terminal 10 in a range in which the output voice of the non-cognitive skills improvement support system 1 can be heard in a space R in which the terminal 10 is installed. The user U may use the non-cognitive skills improvement support system 1 at a position in the space R at which the output voice from the terminal 10 cannot be heard or outside the space R insofar as the input to the non-cognitive skills improvement support system 1 and the output of the message and the helpful information from the non-cognitive skills improvement support system 1 can be achieved via earphones with a microphone, a headset, a wireless camera, and the like wirelessly connected to the non-cognitive skills improvement support system 1.

Here, the helpful information means, for example, information with which the purpose of improving the non-cognitive skills of the user U can be achieved. Specifically, the helpful information includes content information with which the motivation of the user U is improved and the user U becomes positive.

A generation method of the content information can be arbitrarily selected based on, for example, the preliminarily stored preference of the user U, the emotion information generated through the reaction confirmation process for the user U who has reacted to the content information, and the like. The content information may be output from the foundation model 200 by generating the model input information including at least one or more of the physical attribute information (“child” or the like) of the user U, the emotion information (“felling depressed” or the like), the purpose of improving the non-cognitive skills (“want to become positive” or the like), and the effect of requesting the helpful information to improve the non-cognitive skills (“film works,” “musical works,” “artworks,” or the like) via the model input information generating unit 116, and inputting the model input information to the foundation model 200.

The format of the helpful information only needs to be able to be output to the user U, and may be any format of text data (name of the work, URL of a web page on which the work is published), voice data, image data, video data, and the like.

The format of the helpful information may be, for example, information to improve the non-cognitive skills by the user U themselves. Specifically, even when the purpose of improving the non-cognitive skills of the user U cannot be achieved with only the helpful information, such as a package image, a thumbnail image, and a promotional short video of a film work, a URL of a web page on which a video of a musical work is published, and a name and a creator name of an artwork, it is only necessary to be capable of achieving the improvement of the non-cognitive skills by making an opportunity of viewing the film work, the musical work, or the artwork by the user U themselves based on the content of the helpful information. In this case, a self-care method for improving the non-cognitive skills by the user U themselves can be provided even during a period during which the user U does not use the non-cognitive skills improvement support system 1. This allows more efficiently supporting the improvement of the non-cognitive skills of the user U.

### User U Performing Independent Living Training

The user U is a person who performs independent living training, such as rehabilitation, and a person who requests communication with the non-cognitive skills improvement support system 1 during the training or after the training. The non-cognitive skills improvement support system 1 outputs a message or outputs helpful information together with the message to the user U as a participant in the independent living training.

The helpful information in this case means, for example, information with which the purpose of improving the non-cognitive skills of the user U as a participant in the independent living training can be achieved, and specifically, includes relaxation technique information (effleurage, petrissage, and the like) for relieving the pain of the independent living training for the user U.

A generation method of the relaxation technique information can be arbitrarily selected based on, for example, the preliminarily stored chronic disease, symptom, rehabilitation plan, and the like of the user U. The relaxation technique information may be output from the foundation model 200 by generating the model input information including, for example, at least one or more of the physical attribute information (“child,” “the leg is injured,” or the like) of the user U, the emotion information (“rehabilitation is difficult and painful” or the like), the purpose of improving the non-cognitive skills (“want to recover quickly and be able to run again” or the like), and the effect of requesting the helpful information to improve the non-cognitive skills by themselves (“how to relieve a pain in the leg” or the like) via the model input information generating unit 116, and inputting the model input information to the foundation model 200.

### User U Performing Operation Training

The user U is a person who performs operation training, such as e-sports (electronic sports), and a person who requests communication with the non-cognitive skills improvement support system 1 during the training or after the training. The non-cognitive skills improvement support system 1 outputs a message or outputs helpful information together with the message to the user U as a participant in the operation training.

The helpful information in this case means, for example, information with which the purpose of improving the non-cognitive skills of the user U as a participant in the operation training can be achieved, and specifically, includes entertainment information (information on other participant in the training, film works or musical works for refreshing, and the like) for eliminating fatigue and stress caused by the operation training and promoting the improvement of the operation for the user U.

A generation method of the entertainment information can be arbitrarily selected based on, for example, the preliminarily stored preference of the user U, the content of operation training, and the like. The entertainment information may be output from the foundation model 200 by generating the model input information including, for example, at least one or more of the physical attribute information (“twenties” or the like) of the user U, the emotion information (“not good at the operation of a game” or the like), the purpose of improving the non-cognitive skills (“want to improve the skill of operation” or the like), and the effect of requesting the helpful information to improve the non-cognitive skills by themselves (“information on a competitor of a work of e-sports undergoing operation training” or the like) via the model input information generating unit 116, and inputting the model input information to the foundation model 200.

### User U Taking Training

The user U is a person who takes training of e-learning and the like, and a person who requests communication with the non-cognitive skills improvement support system 1 during the training or after the training. The non-cognitive skills improvement support system 1 outputs a message or outputs helpful information together with the message to the user U as a participant in the training.

The helpful information in this case means, for example, information with which the purpose of improving the non-cognitive skills of the user U as a participant in the training can be achieved, and specifically, includes career information (a career path and a career map related to a training content, feedback on a training result, and the like) for eliminating concern and questions regarding the training for the user U.

A generation method of the career information can be arbitrarily selected based on, for example, the preliminarily stored preference of the user U, the content of training, and the like. The career information may be output from the foundation model 200 by generating the model input information including, for example, at least one or more of the physical attribute information (“twenties” or the like) of the user U, the emotion information (“worried about whether to be able to put the training content into practice” or the like), the purpose of improving the non-cognitive skills (“want to be able to complete a series of tasks by themselves as soon as possible” or the like), and the effect of requesting the helpful information to improve the non-cognitive skills by themselves (“want feedback on training results,” “want to know a career path of a participant in the training,” or the like) via the model input information generating unit 116, and inputting the model input information to the foundation model 200.

### User U Performing Creative Work

The user U is a person who creates artistic works and the like, and a person who requests communication with the non-cognitive skills improvement support system 1 during the creation or after the creation. The non-cognitive skills improvement support system 1 outputs a message or outputs helpful information together with the message to the user U as an artistic work creator.

The helpful information in this case means, for example, information with which the purpose of improving the non-cognitive skills of the user U as an artistic work creator can be achieved, and specifically, includes art information (information on other creator of artistic works, ideas, other artistic works for refreshing, and the like) for eliminating decrease in creativity and promoting enhancement of the creativity for the user U.

A generation method of the art information can be arbitrarily selected based on, for example, the preliminarily stored preference of the user U, the content of creation, and the like. The art information may be output from the foundation model 200 by generating the model input information including, for example, at least one or more of the physical attribute information (“twenties” or the like) of the user U, the emotion information (“worried about the creative process that has come to a halt” or the like), the purpose of improving the non-cognitive skills (“want to eliminate a decrease in creativity” or the like), and the effect of requesting the helpful information to improve the non-cognitive skills by themselves (“want to know about artistic works by another as a hint for creation” or the like) via the model input information generating unit 116, and inputting the model input information to the foundation model 200.

As described above, to various kinds of the users U, the non-cognitive skills improvement support system 1 can output the empathetic message that aligns with the emotion of the user U or the combination of the message and the helpful information to the user U. This allows efficiently supporting the improvement of the non-cognitive skills of the user U.

While this disclosure has been specifically described above based on the embodiments, it is needless to say that this disclosure is not limited to the embodiments, and various modifications can be made without departing from the gist of the disclosure.

### DESCRIPTION OF REFERENCE SIGNS

1: Non-cognitive skills improvement support system
10: Terminal
11, 101: Control unit
12: Camera
13, 103: Communication I/F
14: Input unit
15: Output unit
16: Microphone
17, 107: Storage unit
50: Learning screen
52: Character
100: Information processing device
110: Biological information acquiring unit
112: Emotion information generating unit (emotion analyzing unit)
114: Input information acquiring unit
116: Model input information generating unit
117: Input condition analyzing unit
118: Message generating unit (output controlling unit)
120: Evaluating unit
122: Granting unit
124: Reaction evaluating unit
200: Foundation model
200a: Large language model
201: Question receiving unit
202: Answer generating unit
204: Database

1. A non-cognitive skills improvement support system comprising:
an emotion information generating unit configured to generate emotion information based on biological sensor data obtained from a subject, wherein the biological sensor data includes at least one of facial expression data or voice data;
a model input information generating unit configured to generate model input information including at least one of text data, voice data, image data, video data, sensor data, or multimodal data to be input to a foundation model based on the emotion information generated by the emotion information generating unit;
a message generating unit configured to generate a message to improve non-cognitive skills including a message empathetic toward the subject based on an output from the foundation model responsive to the model input information generated by the model input information generating unit; and
an output unit configured to output the message generated by the message generating unit to the subject via at least one of a display device or a reproduction device.

2. The non-cognitive skills improvement support system according to claim 1, wherein
the foundation model is a large language model, and
the model input information is a prompt input to the large language model.

3. The non-cognitive skills improvement support system according to claim 1, further comprising
an input information acquiring unit that acquires input information that the subject inputs to a device, wherein
the model input information generating unit generates the model input information based on the emotion information generated by the emotion information generating unit and the input information acquired by the input information acquiring unit.

4. The non-cognitive skills improvement support system according to claim 3, further comprising
an input condition analyzing unit that analyzes the input information acquired by the input information acquiring unit to generate input condition information including an input proficiency level or a concentration level, wherein
the model input information generating unit generates the model input information based on the emotion information generated by the emotion information generating unit and the input condition information generated by the input condition analyzing unit.

5. The non-cognitive skills improvement support system according to claim 1, wherein
the message generating unit further generates helpful information to improve non-cognitive skills based on the model input information generated by the model input information generating unit.

6. The non-cognitive skills improvement support system according to claim 1, wherein
the emotion information generating unit generates the emotion information based on the biological information of the subject that does not perform an input to a device, and
the output unit outputs the message to the subject by voice.

7. The non-cognitive skills improvement support system according to claim 1, further comprising
a reaction evaluating unit that evaluates a reaction of the subject after the output of the message.

8. The non-cognitive skills improvement support system according to claim 1, wherein
the output unit outputs the message together with a character corresponding to the emotion information.

9. The non-cognitive skills improvement support system according to claim 4, further comprising:
an evaluating unit that evaluates an effort level of the subject for a task based on the input condition information; and
a granting unit that provides a reward to the subject based on an evaluation result by the evaluating unit.

10. A non-cognitive skills improvement support method comprising:
an emotion information generating step of generating emotion information based on biological sensor data obtained from a subject, wherein the biological sensor data includes at least one of facial expression data or voice data;
a model input information generating step of generating model input information including at least one of text data, voice data, image data, video data, sensor data, or multimodal data to be input to a foundation model based on the emotion information generated in the emotion information generating step;
a message generating step of generating a message to improve non-cognitive skills including a message empathetic toward the subject based on an output from the foundation model responsive to the model input information generated in the model input information generating step; and
an output step of outputting the message generated in the message generating step to the subject via at least one of a display device or a reproduction device.
